(19) United States
(12) Patent Application Publication
(10) Pub. No.: US 2025/0385306 A1
(43) Pub. Date: Dec. 18, 2025

(54) FLUORINATED POLYMER ELECTROLYTE FOR ELECTROCHEMICAL CELLS

(71) Applicant: GM Global Technology Operations LLC, Detroit, MI (US)

(72) Inventors: Yun-Yu Lai, Clawson, MI (US); Yifan Zhao, Troy, MI (US); Nathaniel Hardin, Farmington Hills, MI (US); Fang Dai, Troy, MI (US)

(21) Appl. No.: 18/746,638

(22) Filed: Jun. 18, 2024

(51) Int. Cl. H01M 10/0565; H01M 4/02; H01M 4/131; H01M 4/525; H01M 4/66; H01M 10/647

(52) U.S. Cl. CPC H01M 10/0565; H01M 4/131; H01M 4/525; H01M 4/662; H01M 10/647; H01M 2004/027; H01M 2004/028; H01M 2300/0085

(57) ABSTRACT

A fluorinated gel polymer electrolyte for a vehicle battery cell, a battery cell, and a method of forming a fluorinated gel polymer electrolyte. The fluorinated gel polymer electrolyte includes a polymerized gel polymer electrolyte precursor. The gel polymer electrolyte is involatile up to 150 degrees Celsius. The gel polymer electrolyte precursor includes a lithium salt present in the range of 10 to 50 percent by weight of the total weight of the of the gel polymer electrolyte precursor, a fluorinated monomer present in the range of 10 to 50 percent by weight of the total weight of the gel polymer electrolyte precursor, and a non-aqueous organic solvent present in the range of 50 to 90 percent by weight of the total weight of the gel polymer electrolyte precursor.

### BACKGROUND

Electric and hybrid electric vehicle technology is enabled by the development and deployment of rechargeable, secondary batteries, which provide energy to the powertrain. Secondary batteries include lithium ion batteries, which generally include a cathode, anode, separator, and electrolyte. The cathode provides the source of lithium ions and determines the capacity and average voltage of a battery. Various lithium cathode chemistries have been introduced and often include transition metals such as iron, cobalt, or manganese. The anode stores and releases lithium ions received from the cathode when energy is needed. The separator prevents the cathode and anode from contacting and shorting out the battery. The electrolyte provides a medium between the cathode and anode through which the lithium ions travel.

Electrolytes are available in various states including liquid state and solid state. Liquid electrolytes often include a solution of lithium salts in an organic solvent, and optionally include various additional additives. Liquid electrolytes, however, may include trace amounts of water, which may be reactive with lithium. In addition, the electrolytes may be viscous and may leak in certain applications. Solid state electrolytes have been explored as an alternative to liquid electrolytes and include solid particles of, for example, lithium containing compounds such as garnets, lithium nitrides, lithium hydrides, or lithium titanate. These electrolytes do not leak and exhibit relatively low reactivity with electrode material. However, interstices are present between the solid particles as well as between the solid particles and the electrodes, reducing surface contact area of the electrolyte with the electrode. Further, solid state electrolytes may be brittle limiting them to certain applications. Solid polymer electrolytes have also been explored. However, solid polymer electrolytes may exhibit low lithium-ion conductivity and poor mechanical properties.

Thus, while present lithium cathode chemistries achieve their intended purpose, there is a need for new and improved cathode chemistries that offer reduced heat generation and internal resistance at various states of charge while maintaining discharge specific capacities.

### SUMMARY

According to various aspects, the present disclosure is directed to a fluorinated gel polymer electrolyte for a vehicle battery cell. The fluorinated gel polymer electrolyte includes a polymerized gel polymer electrolyte precursor. The gel polymer electrolyte is involatile up to 150 degrees Celsius. The gel polymer electrolyte precursor includes a lithium salt present in the range of 10 percent by weight to 50 percent by weight of the total weight of the of the gel polymer electrolyte precursor, a fluorinated monomer present in the range of 10 percent by weight to 50 percent by weight of the total weight of the gel polymer electrolyte precursor, and a non-aqueous organic solvent present in the range of 50 percent by weight to 90 percent by weight of the total weight of the gel polymer electrolyte precursor.

In embodiments of the above, the gel polymer electrolyte exhibits a degradation temperature in the range of 375 degrees Celsius to 475 degrees Celsius.

In any of the above embodiments, the fluorinated monomer exhibits a molecular weight in the range of 140 grams per mole to 455 grams per mole and the fluorinated monomer includes carbon present in the range of 4 atoms to 12 atoms, fluorine present in the range of 3 atoms to 15 atoms, optionally hydrogen present in the range of 4 atoms to 10 atoms, and optionally 2 atoms of oxygen. In further embodiments, the fluorinated monomer includes one or more monomers selected from the group consisting of: 2,2,3,3,4,4,5,5-octafluorohexamethylene diacrylate, 1,1,1,3,3,3-hexafluoroisopropyl acrylate, 1,1,1,3,3,3-hexafluoroisopropyl methacrylate, 2,2,3,4,4,4-hexafluorobutyl acrylate, 2,2,3,4,4,4-hexafluorobutyl methacrylate, 1H,1H,2H,2H-nonafluorohexyl methacrylate, 1H,1H,2H,2H-tridecafluoro-n-octyl methacrylate, 2,2,2-trifluoroethyl methacrylate, 2,2,3,3,3-pentafluoropropyl methacrylate, 1H,1H,5H-octafluoropentyl methacrylate, 2,2,3,3,4,4,5,5,6,6,7,7-dodecafluoroheptyl methacrylate, 1H,1H,2H,2H-nonafluorohexyl acrylate, 1H, 1H,2H,2H-tridecafluoro-n-octyl acrylate, 2,2,2-trifluoroethyl acrylate, 1H,1H-pentadecafluoro-n-octyl acrylate, 2,2,3,3-tetrafluoropropyl acrylate, 1H,1H,5H-octafluoropentyl acrylate, 3,3,4,4,5,5,6,6,6-nonafluoro-1-hexene, (perfluorohexyl)ethylene, 2-(perfluoropropoxy)perfluoropropyl trifluorovinyl ether, and vinyl trifluoroacetate.

In any of the above embodiments, the non-aqueous organic solvent includes one or more solvents selected from the group consisting of: ethylene carbonate (EC), propylene carbonate (PC), butylene carbonate (BC), fluoroethylene carbonate (FEC), dimethyl carbonate (DMC), diethyl carbonate (DEC), ethyl methyl carbonate (EMC), methyl formate, methyl acetate, methyl propionate, γ-butyrolactone, γ-valerolactone, 1,1,2,2-tetrafluoroethyl-2,2,3,3-tetrafluoropropyl ether (TTE), bis(2,2,2-trifluoroethyl) carbonate (ETFEC), bis(2,2,2-trifluorocthyl) ether (BTFE), 1,1,2,3,3,3-hexafluoropropyl-2,2,2-trifluorocthylether, methyl 3,3,3-trifluoropionate, or ethyl trifluoroacetate, tris(2,2,2-trifluoroethyl) orthoformate (TFEO), bis(2,2,2-trifluoroethyl) carbonate) (BTC), methyl 2,2,2-trifluorocthyl carbonate (FEMC), 1,2-dimethoxyethane (DME), 1,2-diethoxyethane, ethoxymethoxyethane, tetrahydrofuran, 2-methyltetrahydrofuran, 1,3-dioxolane (DOL), sulfolane, diglyme (G2), triglyme (G3), and tetraglyme (G4).

In any of the above embodiments, the gel polymer electrolyte precursor includes one or more initiators selected from the group consisting of: azobisisobutyronitrile (AIBN), benzoyl peroxide (BPO), and tert-butyl peroxide, and the initiator is present in the gel polymer electrolyte precursor in range of 0.1 weight percent to 5 weight percent of the total weight percent of the gel polymer electrolyte precursor.

In further embodiments, the monomer is 2,2,3,3,4,4,5,5-octafluorohexamethylene diacrylate, the non-aqueous organic solvent is fluoroethylene carbonate (FEC) present at 50 percent by weight of the total weight of the solvent and ethyl methyl carbonate (EMC) present at 50 percent by weight of the total weight of the solvent, and the lithium salt is lithium hexafluorophosphate.

According to various additional aspects, the present disclosure is directed to a battery cell for a vehicle. The battery cell includes a cathode electrode, an anode electrode, a separator positioned between the anode electrode and cathode electrode, a gel polymer electrolyte contacting the anode electrode, the cathode electrode, and the separator, and a covering surrounding the cathode electrode, the anode electrode, the separator, and the gel polymer electrolyte. The gel polymer electrolyte includes any of the above mentioned fluorinated gel polymer electrolytes. In embodiments, the gel polymer electrolyte includes a polymerized gel polymer electrolyte precursor. The gel polymer electrolyte precursor includes a lithium salt present in the range of 10 percent by weight to 50 percent by weight of the total weight of the of the gel polymer electrolyte precursor, a fluorinated monomer present in the range of 10 percent by weight to 50 percent by weight of the total weight of the gel polymer electrolyte precursor, and a non-aqueous organic solvent present in the range of 50 percent by weight to 90 percent by weight of the total weight of the gel polymer electrolyte precursor and the gel polymer electrolyte is involatile up to 150 degrees Celsius.

In further embodiments of the above, the fluorinated monomer is 2,2,3,3,4,4,5,5-octafluorohexamethylene diacrylate, the non-aqueous organic solvent is fluoroethylene carbonate (FEC) present at 50 percent by weight of the total weight of the solvent and ethyl methyl carbonate (EMC) present at 50 percent by weight of the total weight of the solvent, and the lithium salt is lithium hexafluorophosphate.

In any of the above embodiments, the gel polymer electrolyte precursor includes one or more initiators selected from the group consisting of: azobisisobutyronitrile (AIBN), benzoyl peroxide (BPO), and tert-butyl peroxide, and the initiator is present in the gel polymer electrolyte precursor in range of 0.1 weight percent to 5 weight percent of the total weight percent of the gel polymer electrolyte precursor.

In any of the above embodiments, the cathode electrode includes a cathode disposed on a cathode current collector and the cathode includes one or more cathode materials selected from the group consisting of: lithium iron phosphate, lithium manganese iron phosphate, lithium cobalt oxide, lithium nickel manganese cobalt oxide, lithium nickel cobalt aluminum oxide, and lithium nickel cobalt manganese aluminum oxide. In further embodiments, the cathode material is lithium nickel manganese cobalt oxide having the formula LiNiₓMn_{y}Co_{1-x-y}O₂, wherein x is in the range of 0.1 to 0.8 and y is in the range of 0.1 to 0.4.

In any of the above embodiments, the cathode current collector includes one or more of materials selected from the group consisting of: aluminum, nickel, and stainless steel.

In embodiments of the above, the cathode includes a plurality of particles disposed on the cathode current collector and a plurality of interstices defined by the plurality of particles and the gel polymer electrolyte is present in the interstices.

In any of the above embodiments, the anode electrode includes an anode current collector includes one or more of copper, nickel, stainless steel, and titanium.

In any of the above embodiments, the anode electrode includes an anode disposed on the anode current collector, and the anode includes one or more anode materials selected from the group consisting of lithium metal, lithium silicon alloy, lithium aluminum alloy, lithium indium alloy, lithium titanate, lithium tin alloy, graphite, hard carbon, activated carbon, a carbon black and graphene mixture, silicon, silicon oxide, a silicon oxide and graphite mixture, tin oxide, aluminum, indium, zinc, germanium, and titanium oxide.

In any of the above embodiments, the battery cell is a 150 milliamp-hour pouch battery cell and exhibits less than a 20 percent loss in capacity retention at 100 cycles of charging for 10 hours and discharging for three hours.

According to yet additional aspects, the present disclosure is directed to a method of forming a fluorinated gel polymer electrolyte. The method includes mixing a lithium salt, a fluorinated monomer, and a non-aqueous organic solvent to form a gel polymer electrolyte precursor, and thermally treating the gel polymer electrolyte precursor at a temperature in the range of 70 degrees Celsius to 90 degrees Celsius for a time period in the range of 50 minutes to 70 minutes. The lithium salt is present in the range of 10 percent by weight to 50 percent by weight of the total weight of the of the gel polymer electrolyte precursor, the fluorinated monomer present in the range of 10 percent by weight to 50 percent by weight of the total weight of the gel polymer electrolyte precursor, and the non-aqueous organic solvent present in range of 50 percent by weight to 90 percent by weight of the total weight of the gel polymer electrolyte precursor.

In further embodiments, the method includes mixing an initiator into the gel polymer electrolyte precursor, wherein the initiator is present in the range of 0.1 percent by weight to 5.0 percent by weight of the total weight of the gel polymer electrolyte precursor.

In any of the above embodiments, the method includes injecting the gel polymer electrolyte precursor into a dry battery cell before thermally treating the gel polymer electrolyte precursor.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates a secondary battery according to embodiments of the present disclosure.

FIG. 2B illustrates a pouch or prismatic battery cell according to embodiments of the present disclosure.

FIG. 2C illustrates a cylindrical battery cell according to embodiments of the present disclosure.

FIG. 3 illustrates a gel polymer electrolyte contacting a cathode and cathode current collector according to embodiments of the present disclosure.

FIG. 4A illustrates an example of a fluorinated monomer according to embodiments of the present disclosure.

FIG. 4B illustrates the fluorinated monomer of FIG. 4A post polymerization according to embodiments of the present disclosure.

FIG. 5 illustrates a method of forming the gel polymer electrolyte according to embodiments of the present disclosure.

FIG. 6 illustrates a graph of a thermogravimetric analysis (TGA) of a fluorinated gel polymer electrolyte according to embodiments of the present disclosure. The horizontal axis represents the temperature (degrees Celsius) and the vertical axis represents the change in weight based upon the weight percentage of the original sample.

FIG. 7 illustrates the effect of cycle number on the discharge capacity as measured for a 150 milliamp-hour single pouch cell. The horizontal axis represents the number of cycles and the vertical axis represents the discharge capacity (milliamp-hours). The charge/discharge cycles use a ten hour charge and a 3 hour discharge.

FIG. 8 is a Nyquist plot illustrating the effect of curing on impedance. The horizontal axis represents the real part of the impedance Z′ (Ohms) and the vertical axis represents the imaginary impedance −Z″ (Ohms).

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to a cathode including domains or layers of a lithium and manganese rich composition and a lithium iron phosphate composition. The cathodes are incorporated into battery cells and secondary batteries. The batteries may then be used in electric or hybrid-electric vehicles including batteries using battery cells employing the cathode compositions. The present disclosure further relates to a methods of forming the cathodes and battery cells.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

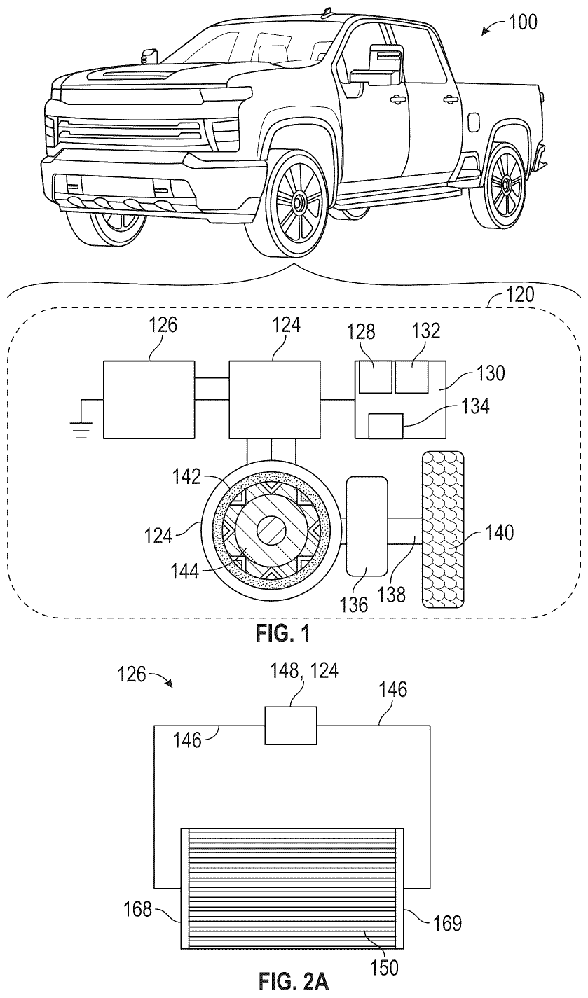

FIG. 1 illustrates a vehicle 100 including a propulsion system 120. The propulsion system 120 generally includes an electric motor 124 and a secondary battery 126 for powering the electric motor 124. Further, in many embodiments of the propulsion system 120, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice-versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134. A combustible fuel powered engine may also be included in the propulsion system of hybrid-electric vehicles.

With reference again to the electric motor 124, the electric motor 124, powered by the battery 126, includes a stator 142 and a rotor 144 arranged with the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotor's 144 rotating field (as caused by physical rotation) generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

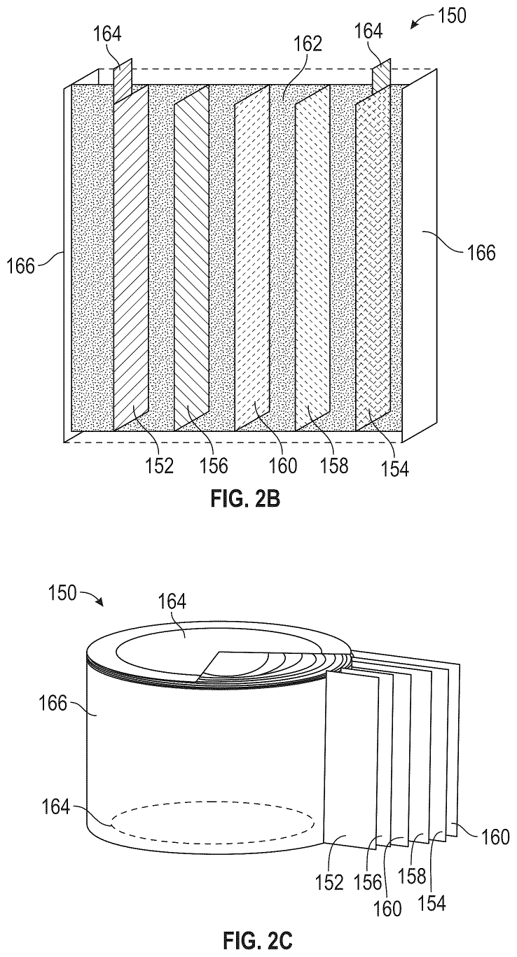

Reference is made to FIGS. 2A, 2B and 2C illustrating an example of a secondary battery 126 for powering an electric vehicle 100, such as the electric vehicle 100 illustrated in FIG. 1. As noted above, secondary batteries 126 are understood as rechargeable batteries, that may be discharged upon application of a load and recharged upon the application of an external power source. Referring to FIG. 2A, 2B, and 2C, the battery 126 is illustrated as being connected to a load 148, such as the electric motor 124. However, other loads 148 include various systems in the vehicle such as climate control systems and infotainment systems. The battery 126 includes one or more battery cells 150, that are assembled together. The battery cells 150 may be, for example, pouch style, prismatic, or cylindrical, discussed further below. With reference to FIGS. 2B and 2C, in particular, during discharge, when a load is applied to the battery 126, Li+ ions move from the anode 158 to the cathode 156 through the separator 160 by way of the gel polymer electrolyte 162. Equivalent electrons e-move through the circuitry 146 from the cathode 156 to the anode 158, providing voltage to the load 124. While charging, upon application of an external voltage, Li+ ions move from the cathode 156 to the anode 158 by way of the gel polymer electrolyte 162 through the separator 160 and may be intercalated into the anode 158.

Each battery cell 150, such as those illustrated in FIGS. 2B and 2C, generally includes a cathode current collector 152, a cathode 156 disposed on the cathode current collector 152, an anode current collector 154, an anode 158 disposed on the anode current collector 154, a separator 160 positioned between the cathode 156 and anode 158, and a gel polymer electrolyte 162. While the illustrated battery cells 150 include one anode 158 (and anode current collector 154) and one cathode 156 (and one cathode current collector 152), the battery cell 150 may alternatively include two or more cathodes 156 (and cathode current collectors 152) and one or more anodes 158 (and anode current collectors 154). In further alternative embodiments, the battery cell 150 may include or one or more cathodes 156 (and cathode current collectors 152) and two or more anodes 158 (and anode current collectors 154). In any of the designs above, one or more separators 160 are interleaved between the cathodes 156 and anodes 158 to prevent the cathodes 156 and the anodes 158 from contacting.

In embodiments, the battery cell 150 of FIG. 2B is configured as a pouch style battery cell or in a prismatic battery cell. In either design, where multiple cathodes 156 and multiple anodes 158 are present, separators 160 are provided between the cathodes 156 and anodes 158. In embodiments, a ribbon shaped separator 160 may be z-folded around cach cathode 156 (and cathode current collector 152) and around each anode 158 (and anode current collector 154). In a pouch style cell, tabs 164 are welded to the cathode current collectors 152 and the anode current collectors 154 and the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164, or terminals, connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

Alternatively, the battery cell 150 of FIG. 2C is configured as a cylinder style battery cell 150. In this design, the cathode current collector 152, anode current collector 154, cathode 156, anode 158, and one or more separators 160 are in the form of long ribbons, which are rolled into a cylinder or jelly roll. Like the prismatic cell, the cover 166 is formed of a relatively rigid casing of aluminum or another material. Tabs 164 are welded to the cathode current collector 152 and anode current collector 154. The tabs 164 connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

In the various styles of battery cells 150 noted above, the cathode current collector 152 and anode current collector 154 are formed from conductive materials. In embodiments, the cathode current collector 152 includes one or more of aluminum, aluminum alloy, nickel, and stainless steel; and the anode current collector 154 includes one or more of copper, copper alloy, nickel, stainless steel, and titanium. The current collectors 152, 154 are illustrated as being in the form of a foil; however, it should be appreciated that other forms may be exhibited. The cathode current collector 152 and anode current collector 154 are impermeable to gas. In embodiments, the cathode current collector 152 exhibits a thickness in the range of 5 micrometers to 50 micrometers, including all values and ranges therein, such as in the range of 8 micrometers to 25 micrometers, and the anode current collector 154 exhibits a thickness in the range of 5 micrometers to 50 micrometers, including all values and ranges therein, such as in the range of 5 micrometers to 25 micrometers.

The cathode 156 includes materials that provide a source of lithium ions (Li+) and can undergo reversible insertion or intercalation of lithium ions, determining the capacity and average voltage of a battery. The cathode material includes, for example, lithium iron phosphate, lithium manganese iron phosphate, lithium cobalt oxide, lithium nickel manganese cobalt oxides, lithium nickel cobalt aluminum oxides, and lithium nickel cobalt manganese aluminum oxide. In embodiments, the cathode material includes lithium nickel manganese cobalt oxides having the general formula LiNiₓMn_{y}Co_{1-x-y}O₂, wherein x is in the range of 0.1 to 0.8 including all values and ranges therein and y is in the range of 0.1 to 0.4, including all values and ranges therein. In further embodiments, the lithium nickel manganese cobalt oxides exhibit at least one of the following formulas: LiNi_{0.3.3}Mn_{0.33}Co_{0.33}O₂, LiNi_{0.5}Mn_{0.3}Co_{0.2}O₂, LiNi_{0.6}Mn_{0.2}Co_{0.2}O₂, and LiNi_{0.8}Mn_{0.1}Co_{0.1}O₂. The cathode 156 exhibits a thickness in the range of is in the range of 85 micrometers to 500 micrometers, including all values and ranges therein. In embodiments, the cathode 156 is coated on the cathode current collector 152 using a deposition process, such as a slurry based process, hot roll pressing process, extrusion or additive manufacturing. The cathode 156 and cathode current collector 152 form a cathode electrode.

The anode 158, anode current collector 154, or both the anode 158 and anode current collector 154 include materials that can undergo reversible insertion or intercalation of lithium ions (Li+) at a lower electrochemical potential than the cathode 156 material, such that an electrochemical potential difference exists between the anode electrode and cathode electrode. The anode material, when present, includes one or more of lithium metal; alloys of lithium such as lithium silicon alloy, lithium aluminum alloy, lithium indium alloy, lithium titanate, and lithium tin alloy; carbon based materials such as graphite, hard carbon (i.c., a non-graphitizing carbon), activated carbon, carbon black and graphene; silicon; silicon based alloys; silicon oxide; silicon based composite materials including a mixture of silicon oxide with graphite; tin oxide; aluminum; indium; zinc; germanium; and titanium oxide; as well as any combination of the above. In embodiments, the anode 158 exhibits a thickness in the range of 50 micrometers to 150 micrometers, including all values and ranges therein. In embodiments, the anode 158 is applied to the anode current collector 154, forming a coating on the anode current collector 154, using a deposition process, such as a slurry based process, hot roll pressing process, extrusion or additive manufacturing. The anode 158 and anode current collector 154 form an anode electrode. In embodiments, the anode is omitted and only the anode current collector 154 forms the anode electrode.

The separator 160 is a porous material formed of an electrically insulative material that prevents the cathode 156 and anode 158 or the cathode 156 and the anode current collector 154 from contacting and potentially causing a short-circuit. The separator 160 is sandwiched, or at least partially enclosed, between the cathode 156 and anode 158, allowing the passage of the lithium ions through the pores of the separator 160. The separator 160 may include one or more of a composite, a polymeric material, and a non-woven material. In embodiments, the separator includes at least one of polyethylene, polypropylene, polyamide, polytetrafluoroethylene, polyvinylidene fluoride, and polyvinyl chloride. In addition, the separator 160 may be filled, i.c., include fillers dispersed therein, wherein the filler includes a material such as glass fiber. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of film or a mesh, such as woven mesh or a slit film. In embodiments, the separator 160 exhibits a thickness in the range of 4 micrometers to 25 micrometers, including all values and ranges therein.

The gel polymer electrolyte 162 provides a medium between the cathode 156 and anode 158 through which lithium ions travel. The gel polymer electrolyte 162 is a fluorinated gel polymer electrolyte. In embodiments, the gel polymer electrolyte 162 includes a polymerized gel polymer electrolyte precursor. The gel polymer electrolyte precursor includes a lithium salt, a fluorinated monomer, and a non-aqueous organic solvent. Optionally, an initiator, an additive, or both an initiator and an additive are also included in the gel polymer electrolyte precursor. The components, i.c., the lithium salts, fluorinated monomer, non-aqueous solvent, the initiator (if present), and the additive (if present) are combined to disperse the lithium salts, fluorinated monomers, and other components that may be present to form the gel polymer electrolyte precursor. The gel polymer electrolyte precursor is injected into a dry battery cell, which is a battery cell 150 that does not yet include a gel polymer electrolyte 162 but is otherwise assembled to include a cathode 156, an anode 158 (if present), a cathode current collector 152, an anode current collector 154, and a separator 160. The gel polymer electrolyte precursor permeates the pores of the porous separator 160 and wets, or otherwise contacts, the surfaces of the cathode 156 and anode 158 as well as the separator 160 prior to the polymerization of the monomers in the gel polymer electrolyte precursor.

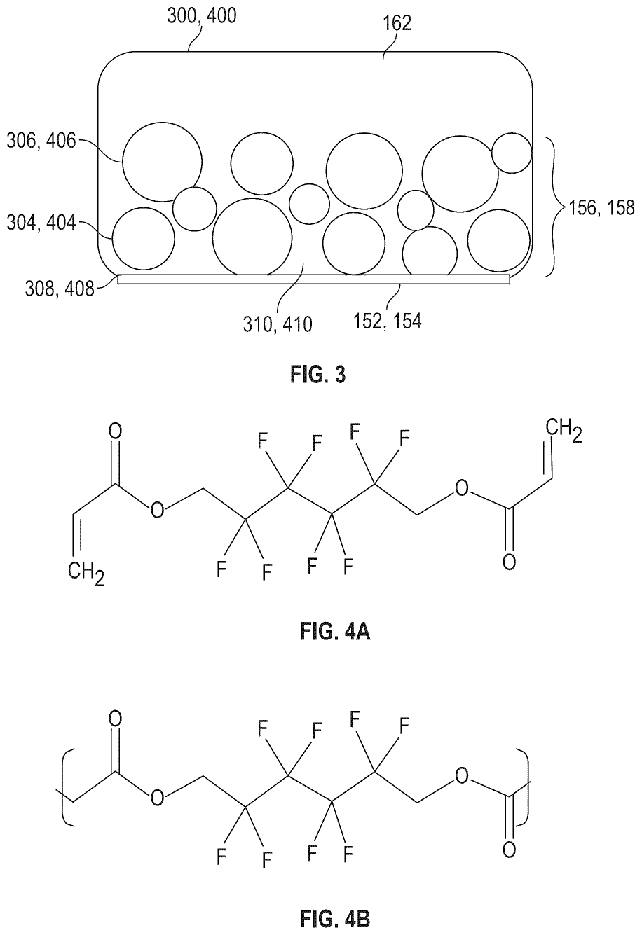

Then the battery cell 150 including the gel polymer electrolyte precursor is thermally treated and exposed to an elevated temperature to polymerize the monomers and form the gel polymer electrolyte 162 within the battery cell 150. FIG. 3 illustrates an embodiment of a cathode electrode 300 including a fluorinated polymer electrolyte 162 and a cathode 156 deposited onto a cathode current collector 152. As illustrated, the fluorinated polymer electrolyte precursor surrounds the particles 304 forming the cathode 156, filling the interstices 310 between the particles 304 and contacts the surfaces 306 of the particles 304 and the surface 308 of cathode current collector 152 before polymerization and maintains contact with the particle surfaces 306 and cathode current collector surface 308 after polymerization. Alternatively, FIG. 3 may illustrate an embodiment of an anode electrode 400, the fluorinated polymer electrolyte 162 and a precursor and after polymerization surrounds the particles 404 forming the anode 158 (if present), filling the interstices 410 between the particles 404 and contacts the surfaces 406 of the particles 404 (if present) and the surface 408 of anode current collector 154.

The lithium salt may include one or more of the following lithium salts: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate)borate (LiB(C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LIFSI), and lithium fluoroalkylphosphate (LiFAP) (Li₃O₄P). The lithium salt is present in the gel polymer electrolyte precursor in the range of 10 percent by weight to 50 percent by weight of the total weight of the gel polymer electrolyte precursor, including all values and ranges therein.

The non-aqueous organic solvent includes one or more of the following solvents: ethylene carbonate (EC), propylene carbonate (PC), butylene carbonate (BC), fluoroethylene carbonate (FEC), dimethyl carbonate (DMC), diethyl carbonate (DEC), ethyl methyl carbonate (EMC), methyl formate, methyl acetate, methyl propionate, γ-butyrolactone, γ-valerolactone, 1,1,2,2-tetrafluoroethyl-2,2,3,3-tetrafluoropropyl ether (TTE), bis(2,2,2-trifluorocthyl) carbonate (ETFEC), bis(2,2,2-trifluoroethyl) ether (BTFE), 1,1,2,3,3,3-hexafluoropropyl-2,2,2-trifluoroethylether, methyl 3,3,3-trifluoropionate, or ethyl trifluoroacetate, tris(2,2,2-trifluoroethyl) orthoformate (TFEO), bis(2,2,2-trifluoroethyl) carbonate) (BTC), methyl 2,2,2-trifluoroethyl carbonate (FEMC), 1,2-dimethoxyethane (DME), 1,2-diethoxyethane, ethoxymethoxyethane, tetrahydrofuran, 2-methyltetrahydrofuran, 1,3-dioxolane (DOL), sulfolane, diglyme (G2), triglyme (G3), tetraglyme (G4), and combinations thereof. In embodiments, the solvent includes fluoroethylene carbonate (FEC) present at 50 percent by weight of the total weight of the solvent and ethyl methyl carbonate (EMC) present at 50 percent by weight of the total weight of the solvent. In preferred embodiments, the solvent has a boiling point of 80 degrees Celsius or higher, including all values and ranges from 80 degrees Celsius to 500 degrees Celsius. The non-aqueous organic solvent is present in the gel polymer electrolyte precursor in range of 50 percent by weight to 90 percent by weight of the total weight of the gel polymer electrolyte precursor, including all values and ranges therein.

The monomer is a fluorinated monomer and includes monomers such as acrylates, methacrylates, acetates, ethylenes, and ethers. The fluorinated monomer is present in the gel polymer electrolyte precursor in the range of 1 weight percent to 10 weight percent of the total weight percent of the gel polymer electrolyte precursor, including all values and ranges therein. In embodiments, the fluorinated monomer has a molecular weight in the range of 140 grams per mole to 455 grams per mole, including all values and ranges therein. In embodiments, the molecular formula of the monomer includes carbon present in the range of 4 atoms to 12 atoms, fluorine present in the range of 3 atoms to 15 atoms, optionally hydrogen present in the range of 4 atoms to 10 atoms, and optionally 2 atoms of oxygen, including all values and ranges therein for each element. Accordingly, hydrogen and oxygen are not present in the molecular formula in some embodiments. In further or alternative embodiments, the monomer includes one or more of the following monomers: 2,2,3,3,4,4,5,5-octafluorohexamethylene diacrylate, 1,1,1,3,3,3-hexafluoroisopropyl acrylate, 1,1, 1,3,3,3-hexafluoroisopropyl methacrylate, 2,2,3,4,4,4-hexafluorobutyl acrylate, 2,2,3,4,4,4-hexafluorobutyl methacrylate, 1H, 1H,2H,2H-nonafluorohexyl methacrylate, 1H, 1H,2H,2H-tridecafluoro-n-octyl methacrylate, 2,2,2-trifluorocthyl methacrylate, 2,2,3,3,3-pentafluoropropyl methacrylate, 1H, 1H,5H-octafluoropentyl methacrylate, 2,2,3,3,4,4,5,5,6,6,7,7-dodecafluoroheptyl methacrylate, 1H,1H,2H,2H-nonafluorohexyl acrylate, 1H, 1H,2H,2H-tridecafluoro-n-octyl acrylate, 2,2,2-trifluoroethyl acrylate, 1H,1H-pentadecafluoro-n-octyl acrylate, 2,2,3,3-tetrafluoropropyl acrylate, 1H,1H,5H-octafluoropentyl acrylate, 3,3,4,4,5,5,6,6,6-nonafluoro-1-hexene, (perfluorohexyl)ethylene, 2-(perfluoropropoxy)perfluoropropyl trifluorovinyl ether, and vinyl trifluoroacetate. In yet further embodiments, the fluorinated monomer is an acrylate or a methacrylate polymerized via free radical polymerization. In one embodiment, the monomer is 2,2,3,3,4,4,5,5-octafluorohexamethylene diacrylate, illustrated in FIG. 4A prior to polymerization and in FIG. 4B after exposure to thermal treatment and polymerization.

In any of the above embodiments, the monomer may be presented with an inhibitor such as butylated hydroxytoluene (BHT), tertiary butylhydroquinone (TBHQ), 2,6-di-tert-butyl-4-methylphenol (DTBMP), hydroquinone monomethyl ether (MEHQ), or 4-tert-butylcatechol (TBC) to prevent polymerization in storage. In embodiments, the inhibitors are removed prior to polymerization. Removal of inhibitors may include washing the monomer with an aqueous solution, such as an NaOH solution, and separation of the monomer, or the use of, for example, reduced pressure distillation or activated granular carbon. Alternatively, the monomer is utilized without removing the inhibitors.

The thermal initiator includes at least one of azobisisobutyronitrile (AIBN), benzoyl peroxide (BPO), and tert-butyl peroxide. The thermal initiator is present in the gel polymer electrolyte precursor in range of 0 weight percent to 5 weight percent of the total weight percent of the gel polymer electrolyte precursor, including all values and ranges therein, such as 0.01 weight percent to 5 weight percent. It should be appreciated in certain embodiments no thermal initiator is present.

Further, the gel polymer electrolyte 162 and gel polymer electrolyte precursor may include a number of additives, such as, but not limited to vinyl carbonate, vinyl-ethylene carbonate, propane sulfonate, and combinations thereof. Other additives may include diluents which do not coordinate with lithium ions but reduce the viscosity of the gel polymer electrolyte precursor and flame retardants.

In any of the above embodiments, the total weight percent of the lithium salts, fluorinated monomer, non-aqueous organic solvent, initiator (if present) and additives (if present) in the gel polymer electrolyte precursor is 100 percent.

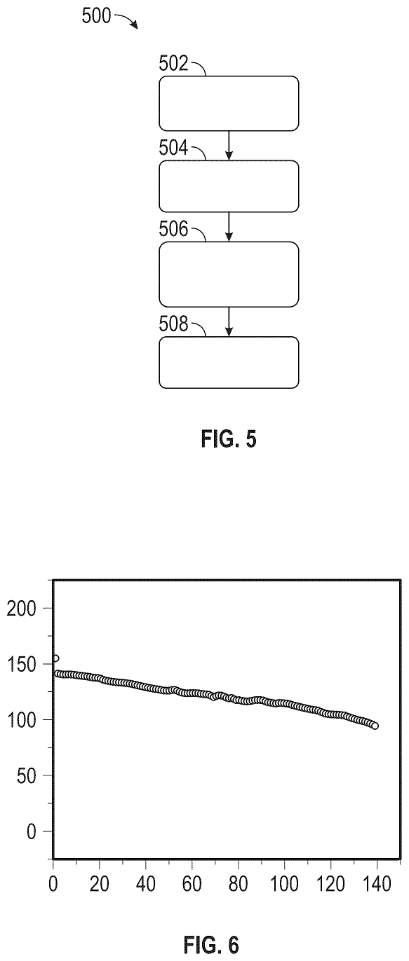

A method of forming the gel polymer electrolyte 162 is illustrated in FIG. 5. The method 500 generally includes at block 502 mixing one or more fluorinated monomers, one or more lithium salts, one or more solvents, optionally one or more initiators, and optionally one or more additives to form the gel polymer electrolyte precursor. At block 504, the gel polymer electrolyte precursor is then injected into a dry battery cell 150 including a cathode 156, a cathode current collector 152, an anode 158 (if present), an anode current collector 154, and a separator 160 positioned in a covering 166 such as a pouch, prismatic cell, or cylinder style cell, as described above with reference to FIGS. 2B through 2C. At block 506, the gel polymer electrolyte precursor in the battery cell 150 is thermally treated by heat treatment at a temperature in the range of 70 degrees Celsius to 90 degrees Celsius including all values and ranges therein, such as 80 degrees Celsius. The thermal treatment is performed for a time period in the range of 50 minutes to 70 minutes, including all values and ranges therein, such as 60 minutes. Thermal treatment is facilitated by placing the battery cell 150 including the gel polymer electrolyte precursor into an oven or by exposure to another heat source. During thermal treatment, the monomer within the gel polymer electrolyte precursor reacts in the solvent to form the gel polymer electrolyte 162 with the lithium salt(s) dispersed through the gel polymer electrolyte 162. If an initiator is present, the elevated temperature degrades the initiator, generating a free radical and initiating free-radical polymerization. In embodiments, the environment, such as in an oven, is inert as the presence of oxygen quenches the polymerization reaction. Alternatively, the gel polymer electrolyte 162 precursor is exposed to sufficient ultraviolet (UV) radiation to polymerize. The UV radiation exhibits, in embodiments, an electromagnetic wavelength in the range of 250 nanometers to 420 nanometers, including all values and ranges therein, may be used to initiate the polymerization reaction. Once the heat treatment (or UV treatment) is completed, the battery cell 150 is sealed at block 508.

The resulting battery cell 150, is then, in embodiments, assembled into a battery 126, which may optionally include additional battery cells 150. In further embodiments, the batteries 126 including a battery cell 150 is assembled into a vehicle 100. In embodiments, the gel polymer electrolyte 162 is involatile, i.c., does not decrease in weight more than 5 percent as determined by thermogravimetric analysis, up to 150 degrees Celsius. As described herein and further below, the thermogravimetric analysis is performed from 25 degrees Celsius to 600 degrees Celsius at a rate of 5 degrees Celsius per minute in an argon gas environment. In further embodiments, the gel polymer electrolyte 162 exhibits a degradation temperature in the range of 375 degrees Celsius to 475 degrees Celsius, including all values and ranges therein such as 425 degrees Celsius. And in yet further embodiments, the gel polymer electrolyte 162 exhibits less than a 20 percent loss in capacity retention of discharge capacity (milliamp-hours) at 100 cycles of a C/10 (ten hour) charge and a C/3 (3 hour) discharge.

### EXAMPLES

A pouch battery cell having 150 milliamp-hour capacity was formed using a nickel rich cathode including LiNi_{0.8}Co_{0.1}Mn_{0.1}O₂ (NCM811), an aluminum foil cathode current collector, a copper foil anode current collector, and a gel polymer electrolyte. The gel polymer electrolyte precursor was prepared from 2,2,3,3,4,4,5,5-octafluorohexamethylene diacrylate monomer, present at 20 percent by weight of the total weight of the gel polymer electrolyte precursor, dispersed in a 1 Molar solution of lithium hexafluorophosphate (LiPF6) dispersed in a fluoroethylene carbonate (FEC) and ethyl methyl carbonate (EMC) solvent present at 80 percent by weight percent by weight of the gel polymer electrolyte precursor, wherein the fluoroethylene carbonate (FEC) is present at 50 percent by weight of the solvent and the ethyl methyl carbonate (EMC) is present at 50 percent by weight of the solvent. The gel polymer electrolyte precursor was injected into the pouch battery cell and thermally treated to 80 degrees Celsius for one hour to form the gel polymer electrolyte. The pouch battery cell exhibited more than 80 percent retention at 100 cycles using a C/10 (ten hour) charge and a C/3 (three hour) discharge.

A second pouch battery cell having 150 milliamp-hour capacity was formed using a nickel rich cathode including Li(Ni_{0.6}Co_{0.2}Mn_{0.2})O₂ (NCM622), an aluminum foil cathode current collector, a copper foil anode current collector, and a gel polymer electrolyte. The gel polymer electrolyte precursor was prepared from 2,2,3,3,4,4,5,5-octafluorohexamethylene diacrylate monomer, present at 20 percent by weight of the total weight of the gel polymer electrolyte precursor, dispersed in a 1 Molar solution of lithium hexafluorophosphate (LiPF6) dispersed in a fluoroethylene carbonate (FEC) and ethyl methyl carbonate (EMC) solvent present at 80 percent by weight percent by weight of the gel polymer electrolyte precursor, wherein the fluoroethylene carbonate (FEC) is present at 50 percent by weight of the solvent and the ethyl methyl carbonate (EMC) is present at 50 percent by weight of the solvent. The gel polymer electrolyte precursor was injected into the pouch battery cell and thermally treated to 80 degrees Celsius for one hour to form the gel polymer electrolyte. The pouch battery cell exhibited more than 80 percent retention of discharge current capacity measured in milliamp hours at 100 cycles using a C/10 (ten hour) charge and a C/3 (three hour) discharge. FIG. 6 illustrates a graph of the change in discharge capacity (illustrated on the vertical, γ-axis) over number of cycles (illustrated on the horizontal, x-axis).

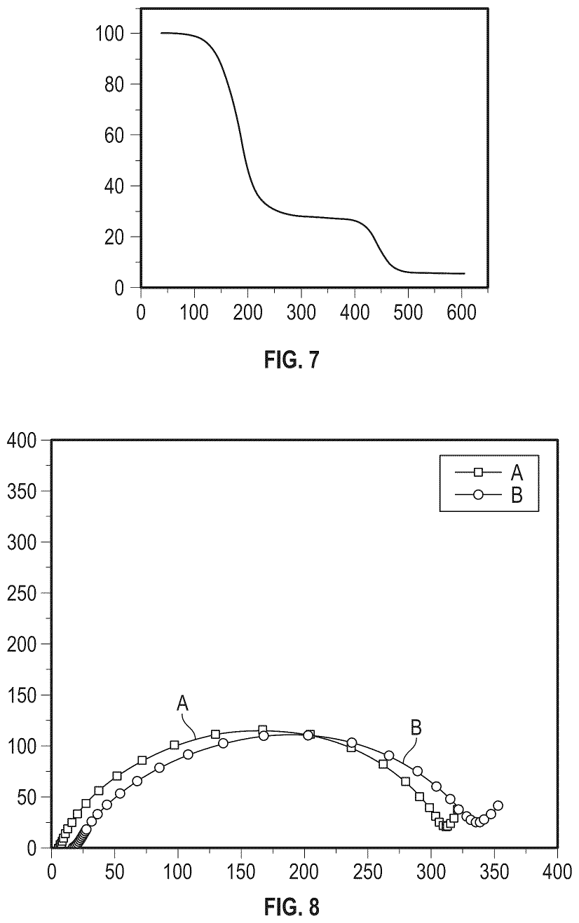

The volatility of the gel polymer electrolyte used with respect to the above two pouch cell batteries was measured using thermogravimetric analysis. FIG. 7 illustrates the change in weight by percentage from the initial weight (illustrated on the vertical, y-axis) as temperature was increased up to 600 degrees Celsius (illustrates on the horizontal, x-axis). As illustrated, the gel polymer electrolyte was involatile up to 150 degrees Celsius. Further the gel polymer electrolyte did not exhibit decomposition until approximately 425 degrees Celsius.

The impedance of the gel polymer electrolyte precursor and gel polymer electrolyte after thermal treatment at 80 degrees Celsius for one hour was measured. FIG. 8 illustrates a Nyquist plot of the change in imaginary impedance, −Z″, measured in ohms (illustrated on the vertical, y-axis) based on the change of real impedance −Z′, measured in ohms (illustrated on the horizontal, x-axis) for the gel polymer electrolyte precursor (A) and the gel polymer electrolyte after thermal treatment (B). After thermal treatment, the polymer gel exhibited relatively higher impedance after thermal treatment, indicating a different ion pathway generated in the gel polymer electrolyte after curing.

The battery cells and secondary batteries including the fluorinated gel polymer electrolyte offers a number of advantages. These advantages include, for example, no leakage of the gel polymer electrolyte. These advantages also include, for example, a stable polymer gel interface between the anode and cathode. These advantages further include being involatile up to 150 degrees Celsius and a degradation temperature of 425 degrees Celsius. These advantages additionally include an increase in interface contact between the cathode, anode, and gel polymer electrolyte.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMS (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A fluorinated gel polymer electrolyte for a vehicle battery cell, comprising:
a gel polymer electrolyte including a polymerized gel polymer electrolyte precursor, wherein the gel polymer electrolyte precursor includes a lithium salt present in the range of 10 percent by weight to 50 percent by weight of the total weight of the of the gel polymer electrolyte precursor, a fluorinated monomer present in the range of 10 percent by weight to 50 percent by weight of the total weight of the gel polymer electrolyte precursor, and a non-aqueous organic solvent present in the range of 50 percent by weight to 90 percent by weight of the total weight of the gel polymer electrolyte precursor, and wherein the gel polymer electrolyte is involatile up to 150 degrees Celsius.

2. The fluorinated gel polymer electrolyte of claim 1, wherein the gel polymer electrolyte exhibits a degradation temperature in the range of 375 degrees Celsius to 475 degrees Celsius.

3. The fluorinated gel polymer electrolyte of claim 1, wherein the fluorinated monomer exhibits a molecular weight in the range of 140 grams per mole to 455 grams per mole and the fluorinated monomer includes carbon present in the range of 4 atoms to 12 atoms, fluorine present in the range of 3 atoms to 15 atoms, optionally hydrogen present in the range of 4 atoms to 10 atoms, and optionally 2 atoms of oxygen.

4. The fluorinated gel polymer electrolyte of claim 3, wherein the fluorinated monomer includes one or more monomers selected from the group consisting of: 2,2,3,3,4,4,5,5-octafluorohexamethylene diacrylate, 1,1,1,3,3,3-hexafluoroisopropyl acrylate, 1,1,1,3,3,3-hexafluoroisopropyl methacrylate, 2,2,3,4,4,4-hexafluorobutyl acrylate, 2,2,3,4,4,4-hexafluorobutyl methacrylate, 1H, 1H,2H,2H-nonafluorohexyl methacrylate, 1H, 1H,2H,2H-tridecafluoro-n-octyl methacrylate, 2,2,2-trifluoroethyl methacrylate, 2,2,3,3,3-pentafluoropropyl methacrylate, 1H,1H,5H-octafluoropentyl methacrylate, 2,2,3,3,4,4,5,5,6,6,7,7-dodecafluoroheptyl methacrylate, 1H,1H,2H,2H-nonafluorohexyl acrylate, 1H,1H,2H,2H-tridecafluoro-n-octyl acrylate, 2,2,2-trifluoroethyl acrylate, 1H,1H-pentadecafluoro-n-octyl acrylate, 2,2,3,3-tetrafluoropropyl acrylate, 1H,1H,5H-octafluoropentyl acrylate, 3,3,4,4,5,5,6,6,6-nonafluoro-1-hexene, (perfluorohexyl)ethylene, 2-(perfluoropropoxy)perfluoropropyl trifluorovinyl ether, and vinyl trifluoroacetate.

5. The fluorinated gel polymer electrolyte of claim 4, wherein the non-aqueous organic solvent includes one or more solvents selected from the group consisting of: ethylene carbonate (EC), propylene carbonate (PC), butylene carbonate (BC), fluoroethylene carbonate (FEC), dimethyl carbonate (DMC), diethyl carbonate (DEC), ethyl methyl carbonate (EMC), methyl formate, methyl acetate, methyl propionate, γ-butyrolactone, γ-valerolactone, 1,1,2,2-tetrafluoroethyl-2,2,3,3-tetrafluoropropyl ether (TTE), bis(2,2,2-trifluoroethyl) carbonate (ETFEC), bis(2,2,2-trifluoroethyl) ether (BTFE), 1,1,2,3,3,3-hexafluoropropyl-2,2,2-trifluoroethylether, methyl 3,3,3-trifluoropionate, or ethyl trifluoroacetate, tris(2,2,2-trifluoroethyl) orthoformate (TFEO), bis(2,2,2-trifluoroethyl) carbonate) (BTC), methyl 2,2,2-trifluoroethyl carbonate (FEMC), 1,2-dimethoxyethane (DME), 1,2-diethoxyethane, ethoxymethoxyethane, tetrahydrofuran, 2-methyltetrahydrofuran, 1,3-dioxolane (DOL), sulfolane, diglyme (G2), triglyme (G3), and tetraglyme (G4).

6. The fluorinated gel polymer electrolyte of claim 5, wherein the gel polymer electrolyte precursor includes one or more initiators selected from the group consisting of: azobisisobutyronitrile (AIBN), benzoyl peroxide (BPO), and tert-butyl peroxide, and the initiator is present in the gel polymer electrolyte precursor in range of 0.1 weight percent to 5 weight percent of the total weight percent of the gel polymer electrolyte precursor.

7. The fluorinated gel polymer electrolyte of claim 1, wherein the monomer is 2,2,3,3,4,4,5,5-octafluorohexamethylene diacrylate, the non-aqueous organic solvent is fluoroethylene carbonate (FEC) present at 50 percent by weight of the total weight of the solvent and ethyl methyl carbonate (EMC) present at 50 percent by weight of the total weight of the solvent, and the lithium salt is lithium hexafluorophosphate.

8. A battery cell for a vehicle, comprising:
a cathode electrode;
an anode electrode;
a separator positioned between the anode electrode and cathode electrode;
a gel polymer electrolyte contacting the anode electrode, the cathode electrode, and the separator; and
a covering surrounding the cathode electrode, the anode electrode, the separator, and the gel polymer electrolyte,
wherein the gel polymer electrolyte is a polymerized gel polymer electrolyte precursor and the gel polymer electrolyte precursor includes a lithium salt present in the range of 10 percent by weight to 50 percent by weight of the total weight of the of the gel polymer electrolyte precursor, a fluorinated monomer present in the range of 10 percent by weight to 50 percent by weight of the total weight of the gel polymer electrolyte precursor, and a non-aqueous organic solvent present in the range of 50 percent by weight to 90 percent by weight of the total weight of the gel polymer electrolyte precursor and the gel polymer electrolyte is involatile up to 150 degrees Celsius.

9. The battery cell of claim 8, wherein the fluorinated monomer is 2,2,3,3,4,4,5,5-octafluorohexamethylene diacrylate, the non-aqueous organic solvent is fluoroethylene carbonate (FEC) present at 50 percent by weight of the total weight of the solvent and ethyl methyl carbonate (EMC) present at 50 percent by weight of the total weight of the solvent, and the lithium salt is lithium hexafluorophosphate.

10. The battery cell of claim 8, wherein the gel polymer electrolyte precursor includes one or more initiators selected from the group consisting of: azobisisobutyronitrile (AIBN), benzoyl peroxide (BPO), and tert-butyl peroxide, and the initiator is present in the gel polymer electrolyte precursor in range of 0.1 weight percent to 5 weight percent of the total weight percent of the gel polymer electrolyte precursor.

11. The battery cell of claim 8, wherein cathode electrode includes a cathode disposed on a cathode current collector and the cathode includes one or more cathode materials selected from the group consisting of: lithium iron phosphate, lithium manganese iron phosphate, lithium cobalt oxide, lithium nickel manganese cobalt oxide, lithium nickel cobalt aluminum oxide, and lithium nickel cobalt manganese aluminum oxide.

12. The battery cell of claim 11, wherein the cathode is lithium nickel manganese cobalt oxide having the formula LiNiₓMn_{y}Co_{1-x-y}O₂, wherein x is in the range of 0.1 to 0.8 and y is in the range of 0.1 to 0.4.

13. The battery cell of claim 11, wherein the cathode current collector includes one or more of materials selected from the group consisting of: aluminum, nickel, and stainless steel.

14. The battery cell of claim 11, wherein the cathode includes a plurality of particles disposed on the cathode current collector and a plurality of interstices defined by the plurality of particles and the gel polymer electrolyte is present in the interstices.

15. The battery cell of claim 8, wherein the anode electrode includes an anode current collector includes one or more of copper, nickel, stainless steel, and titanium.

16. The battery cell of claim 15, wherein the anode electrode includes an anode disposed on the anode current collector, and the anode includes one or more anode materials selected from the group consisting of lithium metal, lithium silicon alloy, lithium aluminum alloy, lithium indium alloy, lithium titanate, lithium tin alloy, graphite, hard carbon, activated carbon, a carbon black and graphene mixture, silicon, silicon oxide, a silicon oxide and graphite mixture, tin oxide, aluminum, indium, zinc, germanium, and titanium oxide.

17. The battery cell of claim 15, wherein the battery cell is a 150 milliamp-hour pouch battery cell and exhibits less than a 20 percent loss in capacity retention at 100 cycles of charging for 10 hours and discharging for three hours.

18. A method of forming a fluorinated gel polymer electrolyte, comprising:
mixing a lithium salt, a fluorinated monomer, and a non-aqueous organic solvent to form a gel polymer electrolyte precursor, wherein the lithium salt is present in the range of 10 percent by weight to 50 percent by weight of the total weight of the of the gel polymer electrolyte precursor, the fluorinated monomer present in the range of 10 percent by weight to 50 percent by weight of the total weight of the gel polymer electrolyte precursor, and the non-aqueous organic solvent present in range of 50 percent by weight to 90 percent by weight of the total weight of the gel polymer electrolyte precursor; and
thermally treating the gel polymer electrolyte precursor at a temperature in the range of 70 degrees Celsius to 90 degrees Celsius for a time period in the range of 50 minutes to 70 minutes.

19. The method of claim 18, further comprising mixing an initiator into the gel polymer electrolyte precursor, wherein the initiator is present in the range of 0.1 percent by weight to 5.0 percent by weight of the total weight of the gel polymer electrolyte precursor.

20. The method of claim 18, further comprising injecting the gel polymer electrolyte precursor into a dry battery cell before thermally treating the gel polymer electrolyte precursor.
